(19) United States
(12) Patent Application Publication
(10) Pub. No.: US 2008/0098983 A1
(43) Pub. Date: May 1, 2008

(54) Cool combustion emissions solution for auto-igniting internal combustion engine

(76) Inventor: Brett M. Bailey, Peoria, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/588,015

(22) Filed: Oct. 26, 2006

(51) Int. Cl. F02B 19/10; F02F 3/24

(52) U.S. Cl. 123/261; 123/259; 123/269

(57) ABSTRACT

Cool combustion refers to combusting fuel in a region of equivalence ratios and temperatures between a soot production region and a NOx production region. Cool combustion is achieved by compressing air in a variable volume of an internal combustion engine beyond an auto-ignition point of a fuel. The compressed air is made to flow in an airflow passage by movement of a piston in the vicinity of top dead center. Fuel is injected into the compressed air stream, auto-ignites and burns in the low emissions region between NOx and soot formation regimes.

### TECHNICAL FIELD

The present disclosure relates generally to low emissions cool combustion in an internal combustion engine, and relates more particularly to a structure and method of injecting fuel into a compressed air stream in a variable volume of an internal combustion engine.

### BACKGROUND

Traditional compression ignition engines operate by injecting fuel into relatively stagnant compressed air in the vicinity of top dead center. The air is compressed to pressures and temperatures that cause directly injected liquid fuel to auto-ignite upon injection after an ignition delay. Current compression ignition engines create undesirable emissions that include nitrous oxide (NOx), unburned hydrocarbons and particulate matter as a byproduct of combustion. NOx is generally a result of the fuel being combusted at or near stoichiometric conditions with temperatures above the NOx production threshold temperature. Particulate matter is generally believed to be the result of a fuel-rich combustion plume resulting from the injection of fuel into a relatively stagnant volume of compressed air. Unburned hydrocarbons are generally believed to be the result of inadequate air being available in the vicinity of the fuel during combustion while temperature and pressure remain above an auto-ignition point.

One relatively new method of auto-igniting fuel in an internal combustion to achieve lower emissions is often referred to as homogeneous charge compression ignition (HCCI). This method includes mixing fuel with air before compressing the mixture to an auto-ignition point. HCCI has proven the ability to produce extremely low NOx emissions. However, HCCI is not without problems. For instance, controlling ignition timing, achieving high load operation and producing excess particulate matter have been challenges facing developers of HCCI engines.

Another approach for reducing emissions has been a reliance upon ever more sophisticated aftertreatment processes. Although aftertreatment can effectively remove substantial amounts of undesirable emissions from internal combustion engine exhaust, they merely treat the symptoms of an emissions problem rather than addressing the problem of how to avoid creating undesirable emissions at the time of combustion.

The present disclosure is directed to these and other problems associated with undesirable emissions from compression ignition engines.

### SUMMARY OF THE DISCLOSURE

A method of operating an internal combustion engine includes compressing a trapped quantity of air in a variable volume beyond an auto-ignition point of a fuel. A majority of the compressed trapped quantity of air is displaced from a first volume to a second volume of the variable volume by moving an engine piston from top dead center. The displacement includes flowing the compressed air away from an engine head and through an airflow passage of the variable volume, which is defined by a surface other than an engine block. Fuel is injected into the compressed air flowing through the airflow passage. The fuel is then auto-ignited.

In another aspect, an internal combustion engine includes a variable volume with portions defined by an engine head, an engine block and a reciprocating piston. The engine includes means for trapping a quantity of air in the variable volume when the piston moves toward top dead center. The variable volume includes an airflow passage that is defined by a surface other than the block, and the variable volume includes a first volume fluidly connected to a second volume by the airflow passage when the piston is at top dead center. Movement of the piston from top dead center displaces fluid in the first volume through the airflow passage, away from the head, to the second volume. A fuel injector is positioned for injection of fuel into the airflow passage. The engine also includes means for actuating the fuel injector to inject fuel when air in the variable volume is above an auto-ignition point of the fuel.

### BRIEF DESCRIPTION OF THE DRAWINGS

FIGS. 1a-d are a sequence of events in an internal combustion engine according to one embodiment of the present disclosure;

FIGS. 2a-d are a sequence of events in an internal combustion engine according to a second embodiment of the present disclosure;

FIGS. 3a-d are a sequence of events in an internal combustion engine according to a third embodiment of the present disclosure;

FIG. 4 is a graph of equivalence ratio φ versus combustion temperature T, that identifies particle matter production and NOx production regimes.

### DETAILED DESCRIPTION

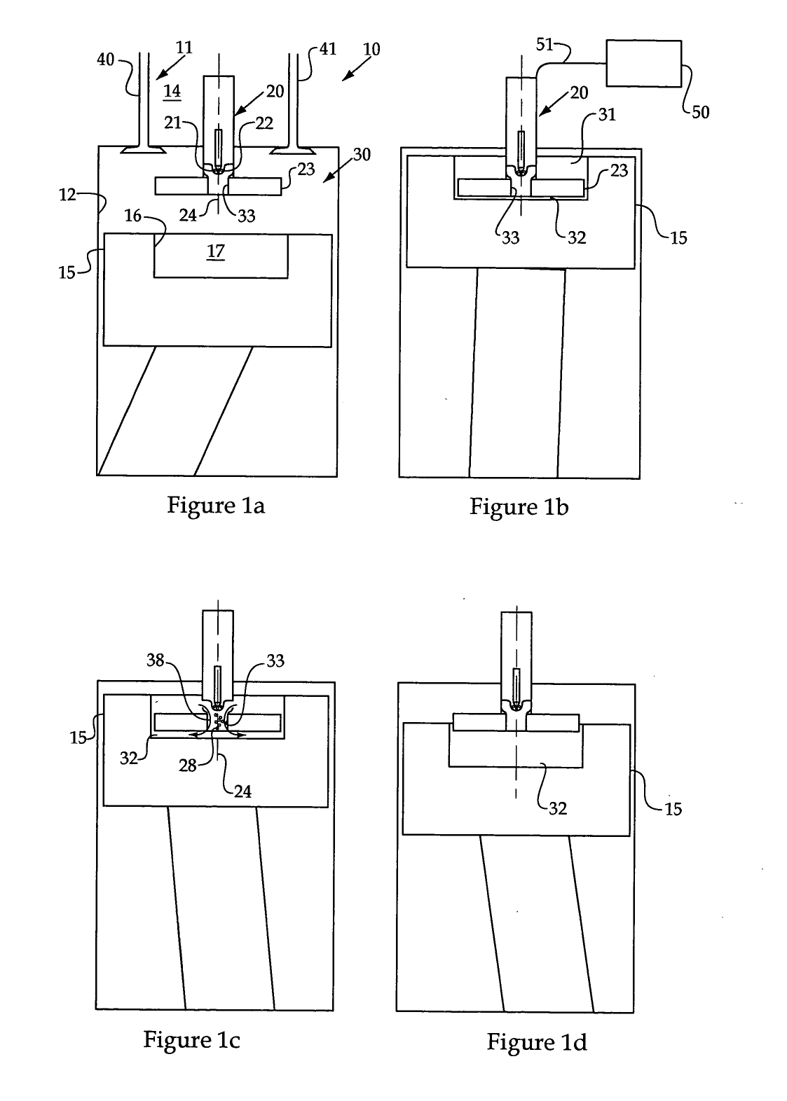

In order to illustrate the breadth of the present disclosure, five embodiments of an internal combustion engine according to the present disclosure are illustrated in FIGS. 1, 2, 3, 4 and 5 respectively. Engines 10, 110, 210 each include an engine body 11, 111, 211 that comprises an engine head 14, 114, 214 and a block 13, 113, 213 that defines at least one engine cylinder 12, 112, 212. A piston 15, 115, 215 reciprocates in each one of the respective cylinders 12, 112, 212. Together, the block 13, 113, 213 head 14, 114, 214 and piston 15, 115, 215 define a variable volume 30, 130, 230. The variable volume is configured to trap a quantity of air when the piston 15, 115, 215 moves toward a top dead center position, as shown in FIGS. 1A, 2A and 3A. The means for trapping the quantity of air includes maintaining valves that open into the variable volume closed while the piston 15, 115, 215 moves toward top dead center. For instance, intake valve 40 and exhaust valve 41 are maintained closed when the piston 15 moves toward top dead center as in a conventional compression ignition engine that burns conventional distillate diesel fuel. Although co-owned U.S. Pat. No. 6,883,468 shows intake and exhaust valves that are maintained closed when its piston is moving toward top dead center, it could not properly be considered as including a means for trapping a quantity of air in a variable volume according to the present disclosure since it includes an open valve that fluidly connects its variable volume to a fixed volume accumulator when its piston moves toward top dead center. Thus, a means for trapping a quantity of air in the variable volume according to the present disclosure means that the trapped air is confined in the variable volume and isolated from mixing with air in other volume(s) of the engine.

The variable volume 30, 130, 230 includes an airflow passage 33, 133, 233 that is defined by a surface other than the engine block 13, 113, 213. The variable volume 30, 130, 230 includes a first volume 31, 131, 231 that is fluidly connected to a second volume 32, 132, 232 by the airflow passage 33, 133, 233 when the piston 15, 115, 215 is at top dead center as shown in FIGS. 1B, 2B, 3B, respectively. Those skilled in the art will recognize that in all of the disclosed embodiments, the first volume 31, 131, 231 is larger than the second volume 32, 132, 232 at top dead center. However, embodiments without this relationship are possible and within the scope of this disclosure. As shown in FIGS. 1C, 2C, 3C, 4 and 5, movement of the piston 15, 115, 215 displaces fluid in the first volume 31, 131, 231 through the airflow passage 33, 133, 233 to the second volume 32, 132, 232 when the movement is from top dead center. The displaced fluid moves away from the head 14, 114, 214 due to the geometry of the variable volume 30, 130, 230. This aspect of the disclosure promotes heat release from combustion away from the head.

A fuel injector 20, 120, 220 is positioned for the injection of fuel into the airflow passage 33, 133, 233. For instance, in the case of the FIG. 1 embodiment, fuel injector 20 includes a nozzle tip 21 with one or more nozzle outlets 22 positioned in airflow passage 33. Fuel injector 20 also includes a projection 23 that is positioned in cylinder 12. The spray patterns produced by the respective fuel injectors 20, 120, 220 are preferably such that thorough mixing occurs with the air during the delay between fuel leaving the fuel injector and auto-ignition in the variable volume. Those skilled in the art will appreciate that the fuel injector need not necessarily be positioned in the airflow passage in order to inject fuel into the airflow passage.

In the illustrated embodiments, the respective fuel injectors 20, 120, 220 are electronically controlled such that a means, such as an electronic controller 50, 150, 250 can control the fuel injector to inject fuel when air in the variable volume 30, 130, 230 is above an auto-ignition point of the fuel. The electronic controllers 50, 150, 250 are in control communication with the respective fuel injectors 20, 120, 220 via a communication line 51, 151, 251 in a conventional manner. Nevertheless, those skilled in the art will appreciate that a simple cam-driven fuel injector without electronic control could still fall within the scope of the present disclosure. Those skilled in the art will appreciate that better results are likely available across an engine's operating range when electronic control affords the ability to inject at any timing independent of engine crank angle. Thus, a means for actuating a fuel injector according to the present disclosure could include electronic control, cam actuation, hydraulic actuation, or simply a fluid connection to a high pressure common rail.

Although not necessary, all of the disclosed embodiments share a symmetry geometry with regard to the engine cylinder 12, 112, 212 so that the nozzle tip of the fuel injector 20, 120, 220 is encircled with the compressed air in the vicinity of top dead center. Nevertheless, those skilled in the art will appreciate that other geometry's could fall within the scope of the present disclosure, such as one of which the compressed air moves transverse to the fuel injector centerline, as shown in prior art U.S. Pat. No. 2,021,744. With the symmetrical and centered geometry of the illustrated embodiments, the fuel injectors 20, 120, 220 allow for injecting fuel in a spray pattern about a cylinder centerline, 24, 124, 224.

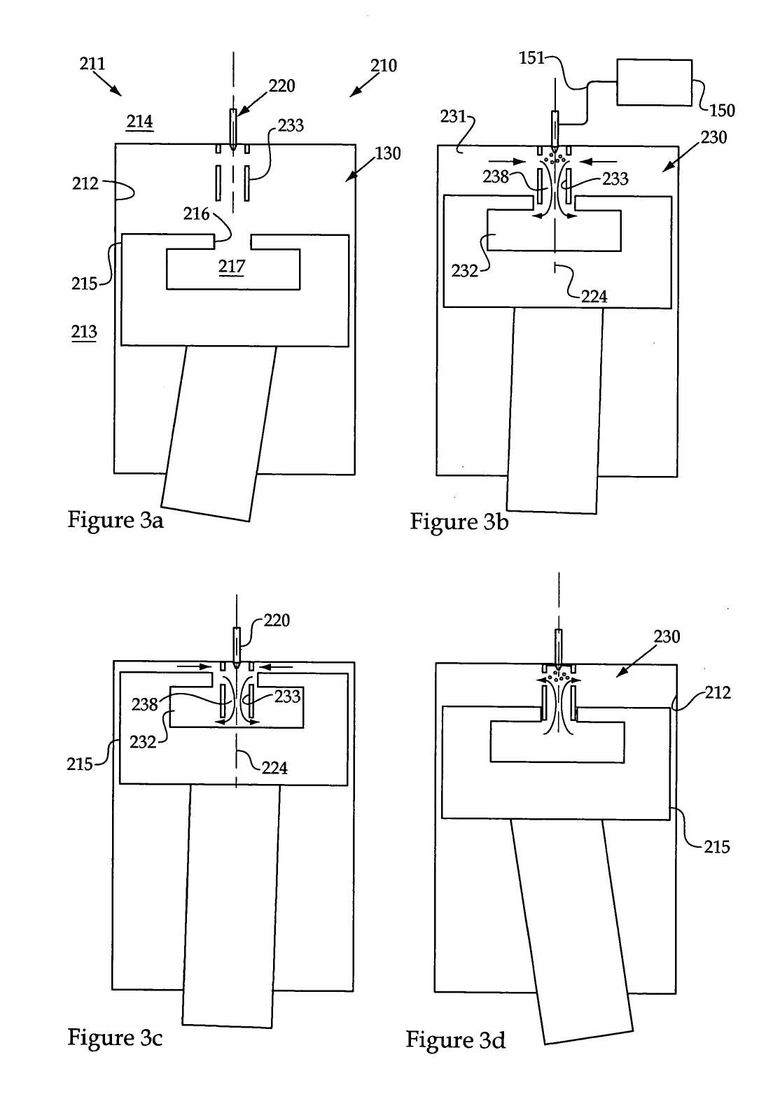

Those skilled in the art will recognize that in some embodiments of the present disclosure, a projection 23, 223 is part of at least one of the engine body, the fuel injector and the piston, and defines at least a portion of the air flow passage 33, 233 respectively. For instance, the embodiments of FIGS. 1 and 3 include a projection 23 and 223 that is received into an opening 16, 216 defined by the engine piston 15, 215. In each of these cases, the opening 16, 216 is part of a cavity 17, 217 defined by the piston 15, 215, respectively. The embodiment of FIG. 1 shows the nozzle tip 20 that includes the nozzle outlets 22 actually positioned inside the projection 23. In each case, the projection 23, 223 channels a segment of the air flow passage 33, 233 in a direction parallel to a centerline 24, 224 of the cylinder 12, 212.

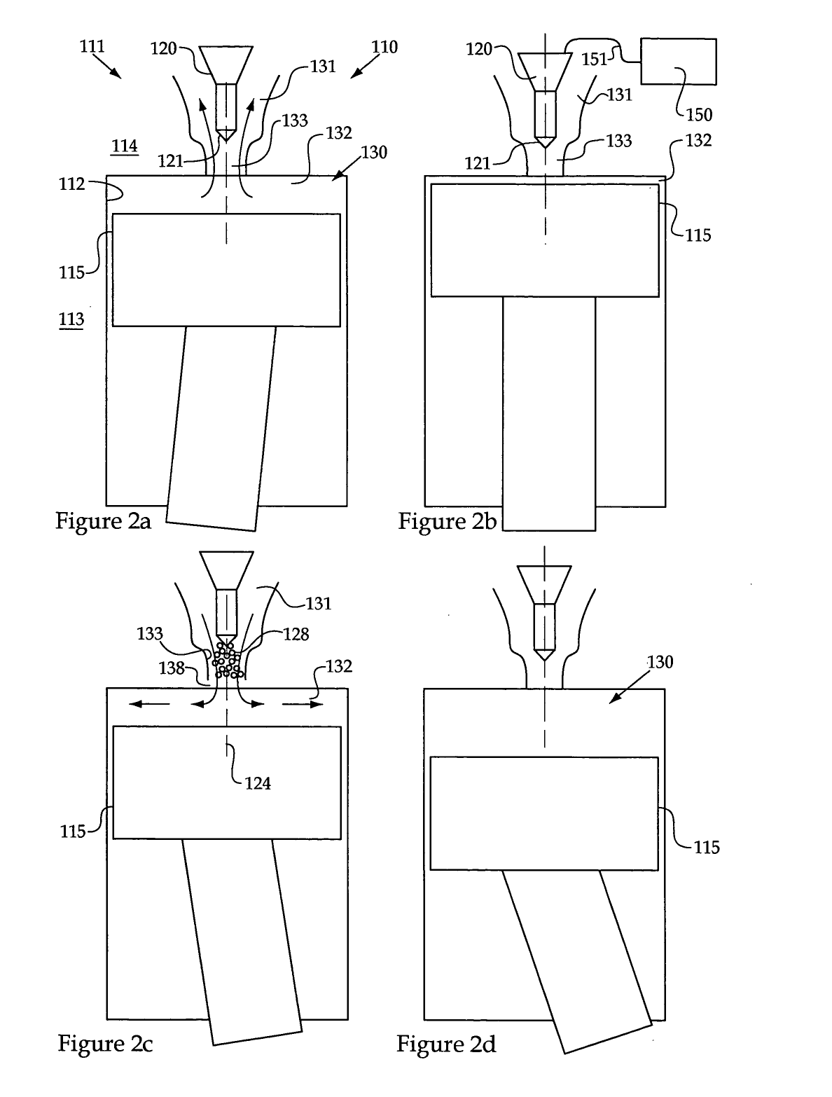

It is important to note that in the embodiments of FIGS. 1, 3, the variable volume is located entirely within the engine cylinder 12, 212 and piston 15, 215. The embodiment of FIG. 2, on the other hand allows for the possibility of a relatively flat topped piston 115. This is accomplished by locating a portion of the variable volume 130 in the engine head 114. In particular, the embodiment of FIG. 2 shows the first volume 131 of the variable volume 130 located in an engine head encircling the nozzle tip 121 of fuel injector 120. By orienting the fuel injector 120 in a co-linear relationship with the cylinder center line 124, the centerline of the nozzle tip is co-linear with the cylinder centerline 124. Thus, the geometry for the FIG. 2 embodiment is such that the engine head 114 channels the air flow passage 133 in a direction parallel to both a centerline of the nozzle tip fuel injector and the cylinder cinder line 124.

### INDUSTRIAL APPLICABILITY

The present disclosure finds general applicability to any internal combustion engine that auto-ignites fuel rather than using some other ignition strategy such as a spark plug or glow plug. Although the present disclosure has been illustrated in the context of injection of liquid distillate diesel fuel, the present disclosure also finds application to other fuels including, but not limited to, gasoline, gaseous fuels, residual fuel oil and any other fuel or mixture of fuels that allow for auto-ignition.

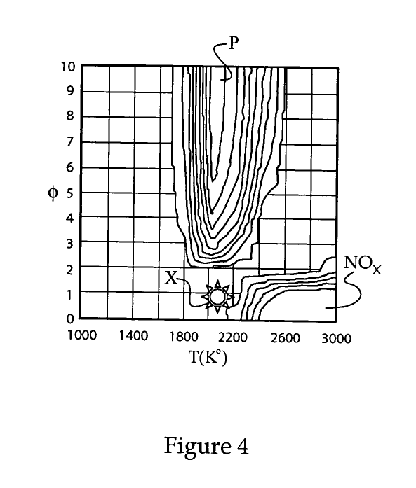

Referring to FIG. 4, a graph of equivalence ratio φ verses combustion temperature T is illustrated in which the regions of particulate matter P and NOx formation are shown. In all cases of the present disclosure, the variable volume 30, 130, 230 has a geometry that allows for combustion at or near a target combustion point X on the graph that results in low particulate and NOx emissions. Unlike homogeneous charge compression ignition, combustion timing for engines according to the present disclosure are closely controlled similar to that of a conventional diesel engine by the injection timing. In other words, by injecting fuel and mixing the fuel with air already compressed to autoignition levels, combustion timing control is more easily achieved than in homogeneous charge compression ignition engines, but without the pressure spike associated with HCCI combustion, but with emissions improvements similar to HCCI operation. Although not shown, the engines of the present disclosure may be equipped with some device, such as a variable valve actuator associated with the intake valve for adjusting the compression ratio across the engine's operating range. Other versions might include some other device for varying compression ratio of all cylinders simultaneously. Such devices are known to those skilled in the art.

When in operation, a quantity of air is trapped in the variable volume 30, 130, 230 and is compressed beyond an auto-ignition point of a fuel (see FIGS. 1A, 2A, and 3A). Depending upon circumstances, fuel injection may occur during the compression stroke when the compressed trapped quantity of air is being displaced from the second volume 32, 132, 232 to the first volume 31, 131, 231. Unlike a conventional diesel engine, no fuel injection will typically occur when the air is compressed and relatively stagnant at top dead center as shown in FIGS. 1B, 2B, and 3B. A majority of the compressed trapped quantity of air is displaced from the first volume, 31, 131, 231 to the second volume 32, 132, 232 of the variable volume 30, 130, 230 by moving the engine piston 15, 115, 215 away from top dead center. During this displacement, compressed air is flowed away from the engine head 14, 114, 214 through the air flow passage 33, 133, 233 which is defined by a surface other than the engine block 13, 113, 213. The present disclosure seeks to flow the compressed air away from the engine block in order to combust the fuel in a way that avoids excess heat transfer to the engine head and/or block in order to boost the efficiency of the engine on par with that of other conventional engines. Those skilled in the art will appreciate that, although the stagnation pressure and temperature of the compressed air is above an auto-ignition point of the fuel, the conditions locally in the air flow passage 33, 133, 233 may drop below auto-ignition conditions briefly due to the velocity of the flow. In all cases of the disclosure, fuel is injected into the compressed air flowing through the air flow passage. The fuel is then auto-ignited, typically after some ignition delay due either to the conditions in the cylinder, moisture content of the air, an ignition delay associated with the particular fuel, or auto-ignitions conditions re-emerging upon the air/fuel mixture leaving the air flow passage 33, 133, 233.

The displacement of the compressed air is accomplished by dividing the compressed air via movement of the piston 15, 115, 215 into at least two volumes that are separated by the air flow passage 33, 133, 233 in response to the engine piston being at top dead center. Although not necessary, the geometry of the variable volume 30, 130, 230 and the injection timing are such that the fuel auto-ignites in a combustion zone that is isolated from the cylinder wall defined by the engine block 13, 113, 213. In the case of the embodiments of FIGS. 1 and 3, the combustion zone is located primarily in the cavity 17, 217 that is defined by the piston 15, 215. In the case of the embodiment of FIG. 2, the combustion zone is located centrally toward the center of the cylinder 112 so that combustion should be occurring and nearly complete before contact is made with the cylinder wall defined by the engine block 113 as shown in FIGS. 2C and 2D.

In most instances, the fuel is preferably injected during the expansion stroke, as shown in FIGS. 1C, 2C, 3B-C. However, the present disclosure recognizes that as the expansion stroke continues, auto-ignition conditions will eventually cease to exist as the volume of the variable volume 30, 130, 230 grows. The fuel should be injected and ignited before the end of auto-ignition conditions. On the other hand, the present disclosure also recognizes that it may be desirable to inject some or all of the fuel during the compression stroke while the piston is moving before the piston arrives at top dead center. For instance, in cases where the total amount of desired fuel simply can not be injected during the expansion stroke, a portion of the fuel may be injected during the compression stroke, such as at high load operating ranges of the engine. Those skilled in the art will appreciate that the compressed air will be displaced from the second volume 32, 132, 232 to the first volume 31, 131, 231 as the piston 15, 115, 215 approaches top dead center during the compression stroke. The movement of the compressed air through the air flow passage 33, 133, 233 during the compression stroke is similar but in an opposite direction to the air flow occurring in the expansion stroke. Nevertheless, those skilled in the art might find it advantageous to inject fuel during the compression stroke, during the expansion stroke, or both, but may or may not during the relatively stagnant conditions existing in the immediate vicinity of top dead center. In all cases of the present disclosure it is the movement of the engine piston that displaces compressed air through the air flow passage 33, 133, 233, rather than via some other means such as the opening of a valve, as shown in co-owned U.S. Pat. No. 6,883,468. Those skilled in the art will appreciate that the present disclosure also contemplates other means (not shown) for effecting the combustion characteristics of the fuel. For instance, an engine according to the present disclosure could be equipped with exhaust gas recirculation equipment without departing from the present disclosure.

Those skilled in the art will appreciate that spray patterns of the present disclosure could take many different forms. For instance, in the embodiments of FIGS. 1-3, the fuel injector would have a spray pattern and hole distribution similar to that of a conventional distillate diesel fuel injector. Those skilled in the art will appreciate that fuel injectors according to the present disclosure may need to utilize substantially lower injection pressures than that necessary in conventional fuel injectors. Because the compressed air is moving in the vicinity of the nozzle outlets, the mixing normally accomplished with high injection pressures and conventional diesel engines is not necessary. Thus, substantially lower injection pressures should make the present disclosure less expensive to manufacture in conventional fuel injection systems, and possibly more readily applicable as a retrofit to existing engines.

The key to the cool combustion solution taught in the present disclosure is the mixing of fuel with air/combustion gases within the combustion chamber. The key to the reduction in undesirable emissions is to reduce the residence time that the fuel is combusting at or near stoichiometric conditions with temperatures above the NOx generation threshold as shown in the graph of FIG. 4. Combustion can be completed at lean conditions due to the auto-ignition characteristics of liquid fuels under high pressure created by a reciprocating engine with a diesel level high compression ratio. In all versions of the present disclosure, air is brought to the fuel instead of the prevailing diesel technology logic that is focused on bringing the fuel to the air. The paradigm switch of the present disclosure accomplished via the mixing reduces the residence time that the fuel/air mixture is above the NOx production threshold to produce NOx emissions. Since the fuel is mixed in the center of the combustion chamber, the fuel has limited interaction with the low temperature walls, reducing the combustion quenching typical in diesel engines, and the undesirable emissions associated with poor combustion adjacent the cylinder head and walls. Finally, the elimination of locally fuel rich diesel combustion plumes reduces the production of particulate matter.

Due to the geometry of the variable volume and the inclusion of an air flow passage 33, 133, 233, the fuel injection can be ramped up as air enters the combustion zone to maximize the natural air motion along with obtaining the optimum combustion temperature and highest efficiency for targeted emissions levels.

Those skilled in the art will appreciate that engines of the present disclosure could benefit from a variety of rate shaping injection pressure control variable compression ratio exhaust gas recirculation variable valve actuation and other known techniques currently being explored to reduce emissions at one or more operating conditions.

The present description is for illustrative purposes only, and should not be construed to narrow the breadth of the present disclosure in any fashion. Thus, those skilled in the art will appreciate the various modifications might be made to the presently disclosed embodiments without departing from the intended spirit and scope of the present disclosure. Other aspects, features and advantages will be apparent upon an examination of the attached drawing Figures and appended claims.

What is claimed is:

1. A method of operating an internal combustion engine, comprising the steps of:
compressing a trapped quantity of air in a variable volume beyond an auto-ignition point of a fuel;
displacing a majority of the compressed trapped quantity of air from a first volume to a second volume of the variable volume by moving an engine piston away from top dead center;
the displacing step including flowing the compressed air away from an engine head and through an air flow passage of the variable volume, which is defined by a surface other than a block;
injecting the fuel into the compressed air flowing through the air flow passage;
auto-igniting the fuel.

2. The method of claim 1 wherein the flowing step includes a step of encircling a nozzle tip of the fuel injector with the compressed air.

3. The method of claim 1 including a step of dividing the compressed air among at least two volumes of the variable volume separated by the air flow passage in response to the engine piston being at the top dead center position.

4. The method of claim 1 wherein the injecting step includes a spray pattern about a cylinder centerline.

5. The method of claim 1 wherein the auto-igniting step is performed in a combustion zone isolated from the cylinder wall.

6. The method of claim 1 wherein the injecting step includes a second amount of fuel;
injecting a first amount of fuel before top dead center.

7. The method of claim 1 wherein the flowing step includes channeling the compressed air flow around a nozzle tip and in a direction parallel to a centerline of the nozzle tip of the fuel injector.

8. The method of claim 1 wherein the fuel is a liquid at a time of the injecting step.

9. The method of claim 1 wherein the auto-igniting step is performed in a cavity defined by the engine piston.

10. The method of claim 1 wherein the auto-igniting step is performed away from a cylinder wall and the engine head.

11. An internal combustion engine comprising:
a variable volume that includes portion defined by an engine head, a block and a reciprocating piston;
means for trapping a quantity of air in the variable volume when the piston moves toward top dead center;
the variable volume including an air flow passage that is defined by a surface other than the block, and the variable volume including a first volume fluidly connected to a second volume by the air flow passage when the piston is at top dead center;
movement of the piston away from top dead center displaces fluid in the first volume through the air flow passage and away from the engine head to the second volume;
a fuel injector being positioned for injection of fuel into the air flow passage; and
means for actuating the fuel injector to inject fuel when air in the variable volume is above an auto-ignition point of the fuel.

12. The internal combustion engine of claim 11 wherein the first volume is larger than the second volume when the piston is at the top dead center position.

13. The internal combustion engine of claim 12 including a projection that is part of at least one of the engine body, the fuel injector and the piston, and defines at least a portion of the air flow passage.

14. The internal combustion engine of claim 13 wherein the piston defines an opening that receives the projection when the piston is at the top dead center position.

15. The internal combustion engine of claim 13 wherein a nozzle tip of the fuel injector is positioned inside the projection.

16. The internal combustion engine of claim 12 wherein the projection channels a segment of the air flow passage in a direction parallel to a centerline of the cylinder.

17. The internal combustion engine of claim 12 wherein the variable volume includes a cylinder, and the first volume includes a chamber disposed in a head of the engine body.

18. The internal combustion engine of claim 17 wherein the nozzle tip centerline is co-linear with a cylinder centerline.

19. The internal combustion engine of claim 17 wherein the engine head channels the air flow passage in a direction parallel to a centerline of a nozzle tip of the fuel injector.

20. The internal combustion engine of claim 11 including means, including a geometry of the variable volume and an injection timing controller, for combusting the fuel in a region of equivalence ratios and temperatures between a soot production region and a NOx production region.
